(19) United States
(12) Patent Application Publication
(10) Pub. No.: US 2011/0224094 A1
(43) Pub. Date: Sep. 15, 2011

(54) METHOD FOR IDENTIFYING AND SELECTING DRUG CANDIDATES FOR COMBINATORIAL DRUG PRODUCTS

(75) Inventors: Mikkel Wandahl Pedersen, Alleroed (DK); Per-Johan Meijer, Koebenhavn N (DK); Allan Jensen, Fredensborg (DK)

(73) Assignee: Symphogen A/S, Kgs. Lyngby (DK)

(21) Appl. No.: 13/122,713

(22) PCT Filed: Oct. 6, 2009
(86) PCT No.: PCT/DK2009/050264

§ 371 Date: May 12, 2011

Related U.S. Application Data
(60) Provisional application No. 61/103,144, filed on Oct. 6, 2008.

(30) Foreign Application Priority Data
Oct. 6, 2008 (DK) PA 2008 01405

(51) Int. Cl. C40B 30/04; C40B 30/06; C40B 30/00; C40B 30/08

(52) U.S. Cl. 506/9; 506/10; 506/7; 506/11

(57) ABSTRACT

A method for identifying and selecting chemical entities that contributes to a functional effect in the development of new combinatorial drugs. The combinations of two or more chemical compounds show a synergistic effect. The compounds can be e.g. antibodies, antibiotics, anti-cancer agents, anti-AIDS agents, anti-growth factors, antiviral agents, soluble receptors, cytokines, RNAi's, vaccines and mixtures thereof. The method comprises a) providing n samples each comprising a chemical entity, b) mixing 2 or more of the n samples in all possible combinations, c) subjecting this mixture to a functional assay in order to identify entities contributing to the functional effect. The steps a-c are repeated on the chemical entities from step c which contribute to the functional effect.

### FIELD OF THE INVENTION

The present invention relates to methods for identifying and selecting chemical entities that possess or contribute to a functional effect. This identification and selection is useful in the discovery and development of new combinatorial drugs, in which a combination of two or more chemical compounds together shows a synergistic effect, e.g. for identifying combinations of chemical entities that can lead to an improved treatment or prophylaxis of diseases. The present invention also relates to methods for identifying and selecting the optimal stoichiometric ratio between chemical entities to obtain a combinatorial drug showing optimal potency and efficacy.

### BACKGROUND OF THE INVENTION

The human antibody response is by nature polyclonal. While most all of the recombinant antibody products that have been developed and commercialized thus far are monoclonal antibodies, in recent years a new class of polyclonal antibody products has also been developed. These are recombinant antibody compositions comprising two or more distinct antibodies binding the same or different targets, and can be produced either as “cocktails” of recombinant monoclonal antibodies, each of which are manufactured individually, or as recombinant polyclonal antibodies manufactured in a single batch. The latter approach is described by Wiberg et al. in Biotechnol. Bioeng. 94:396-405 (2006). Logtenberg (Trends in Biotechnology, 25(9): 390-394, 2007) has reviewed the literature on antibody combinations or cocktails and describes examples of synergistic or additive effects of antibody cocktails on a number of targets, including viruses, soluble molecules such as toxins or growth factors, and cell-bound molecules such as HER-2 and other cancer-related cell surface molecules. Logtenberg does not provide any guidance on how to design synergistic antibody combinations.

Bregenholt & Haurum (Expert Opin Biol Ther. 2004 March; 4(3):387-96) teach that to offer broad protection against biowarfare agents such as viruses and bacteria in a large population, pathogen-specific polyclonal antibodies should ideally encompass a broad range of reactivities against the given phenotype in order to prevent the microorganism from escaping neutralising antibodies through mutations in the epitopes recognised.

Bregenholt et al. (Curr Pharm Des. 2006; 12(16):2007-2015) describe guidelines for designing virus-specific polyclonal antibody drugs. They conclude that the antibody repertoire should be selected to cover as broad a range of neutralising epitopes as possible, while maintaining an antibody composition resembling the neutralising human immune response as closely as possible.

WO 2007/101441 discloses a recombinant polyclonal anti-RSV antibody. In particular, an anti-RSV recombinant polyclonal antibody (rpAb) which is directed against multiple epitopes on both the G and F proteins is disclosed. Preferably, G protein epitopes belonging to the conserved group and potentially also the subtype-specific group and the strain-specific group are covered by the anti-RSV rpAb.

WO 2006/007850 discloses a recombinant polyclonal anti-RhesusD antibody with potential advantages over monoclonal anti-RhD antibodies. By covering every potential RD epitope by more than one antibody, an anti-RhD rpAb composition can be used in the prophylactic treatment of both RhD(−) and RhDVI females bearing a RhD(+) child irrespective of the RhD(+) subtype.

WO 2007/065433 discloses a recombinant polyclonal anti-orthopoxvirus antibody. It is stated that it is advantageous for the polyclonal antibody to comprise distinct antibodies directed against multiple IMV and/or EEV particle proteins and preferably also against multiple epitopes on individual IMV/EEV proteins. Further, antibodies with reactivity against orthopoxvirus related regulators of complement activation (RCA) as a desired component of an anti-orthopoxvirus rpAb are described.

Devaux et al. (Mol. Cell. Chem. 74:117-128 (1987) describe use of monoclonal antibodies for inhibition of Staphylococcus aureus nuclease, including assays performed on combinations of two different antibodies to test for possible cooperative effects.

Monoclonal antibodies are increasingly used in combination therapy together with e.g. cytostatic agents, chemotherapeutics, tyrosine kinase inhibitors, and other antibodies (e.g. Herceptin® together with Avastin®). For these therapeutic regimens there is a need for a rational design of the combination therapies to ensure that the optimal combination is chosen.

Other compounds that are used clinically in combination include antibiotics, anti-cancer agents, anti-AIDS agents, anti-growth factors, antiviral agents, soluble receptors, RNAi's and vaccines.

When designing combinatorial drugs two different goals can be aimed at. In one type of combinatorial drug, the chemical compounds may possess or contribute to the same functional effect, but when combined and administered together they show a synergistic effect. In another type of combinatorial drug the chemical compounds may show different functional effects, and hence one drug capable of treating more than one medical condition can be developed.

When a large number of potential drug candidates are to be included into a mixture, there is a need for a rational drug design that will ensure that synergy will be achieved, including in cases where an optimal drug design is not clear from the outset, but has to be established empirically. The need for rational drug design is also present in even more complex cases where e.g. antibodies are mixed with small molecule drugs to provide a combination treatment.

The challenge of identifying an optimal mixture of different drug candidates is particularly relevant for polyclonal antibody compositions, where the aim is to provide a mixture of different monoclonal antibodies that specifically bind a particular target antigen, thereby mimicking to the greatest extent possible the natural antibody response as it exists in humans and non-human animals. One challenge is just determining the “optimal” number of different antibodies in a particular polyclonal antibody composition, e.g. whether two or three antibodies will provide a therapeutic effect that is approximately as good as the effect obtained by five or ten antibodies. Even if the approximate number of different antibodies in a composition is determined in advance, for example based on production cost considerations, the task of identifying an optimal combination is by no means trivial. For example, if the aim is to provide a polyclonal composition comprising five antibodies and there are 30 candidate antibodies from which these are to be selected, the number of unique combinations of five antibodies is 142,506, and if a polyclonal composition comprising six antibodies is to be selected from 36 candidate antibodies, the number of unique combinations is nearly two million.

### SUMMARY OF THE INVENTION

It is the aim of the present invention to provide a rational method for evaluation of mixtures of two or more entities from a plurality of chemical entities, typically more than ten, in order to identify mixtures with a desired functional effect. Mixtures identified by this method may either show a synergistic effect with regard to one specific functional parameter or they may show two or more functional effects resulting from the fact that different chemical entities possessing different functional effects are present together in the same drug.

Accordingly, a first aspect the present invention relates to a method for identifying and selecting chemical entities possessing or contributing to a functional effect in order to provide a mixture comprising at least two chemical entities showing a desired functional effect, said method comprising the steps of:
a) providing n samples each comprising a chemical entity to be tested;
b) mixing two or more of said n samples in all possible combinations in order to obtain a first set of mixtures to be tested;
c) subjecting said first set of mixtures to a functional assay capable of measuring a functional parameter in order to identify chemical entities contributing to the functional effect;
d) selecting m samples each comprising a chemical entity contributing to the functional effect in step c), wherein m is less than n;
e) mixing two or more of said m samples in all possible combinations in order to obtain a second set of mixtures to be tested;
f) subjecting said second set of mixtures to a functional assay capable of measuring a functional parameter in order to identify chemical entities contributing to the functional effect; and
g) selecting a mixture possessing the desired functional effect.

The above method is unique in that it provides information on all possible mixtures of the n samples to be tested in a rational manner. All possible mixtures are investigated with regard to a functional effect, allowing the mixture showing the optimal functional effect to be identified, and also making it possible to select compounds that enhance the function of other compounds.

In cases where a large number of samples are to be tested, the basic method of the invention as outlined above may be further rationalized by including additional method steps. Firstly, the n samples are divided into subgroups, after which the samples in each subgroup are subjected to method steps a, b and c, and optionally also steps d, e and f. In each group, samples are then selected based on the results obtained in step c, and optionally in step f, for example based on potency or efficacy criteria, and new mixtures only comprising these most potent chemical entities are then mixed and tested. In this way, the amount of work to be performed by preparing mixtures and performing the functional assays is kept to a minimum. In other cases, a mixture comprising a considerable number of chemical entities may be aimed at, and in such cases the most potent mixtures comprising a smaller number of chemical entities are first identified and selected, after which these selected mixtures are mixed and analyzed. In this way the method according to the present invention is modified so as to provide a systematic and rational method for identifying the most potent and efficient mixture with a minimum of time and effort.

Due to the systematic and rational mode of operation of the method of the present invention, it is well-adapted for automation, for instance by robotics.

In another aspect the present invention relates to a method for identifying and selecting an optimal stoichiometric ratio between chemical entities in a mixture comprising at least 2 chemical entities, said mixture showing a desired functional effect, the method comprising the steps of:
aa) providing p samples each comprising one chemical entity to be present in the mixture,
bb) diluting each of said p samples q times in order to obtain p series of samples each comprising the same chemical entity at different concentrations,
cc) mixing 2 or more of the samples obtained in steps aa and bb in all possible combinations in order to obtain mixtures to be tested,
dd) subjecting said mixtures to a functional assay capable of measuring a functional effect in order to identify the relationship between the measured functional effect and the concentration of the chemical entities in the mixture, and
ee) selecting the mixture possessing the desired functional effect.

This allows the optimal stoichiometric ratio between the chemical entities present in the mixture to be identified in a systematic and rational manner.

### BRIEF DESCRIPTION OF THE DRAWINGS

FIG. 1 shows a schematic diagram of one way of performing the selection process according to the present invention for identifying the most potent combinations of a range of drugs.

FIG. 2 shows a schematic illustration of a layout of a receiver plate after addition of a first, second and third layer of 8 drug candidates to a 96 well plate. A) Layer 1, B) layers 1+2 and C) layers 1+2+3. The 8 drug candidates are shown in different shades of grey.

FIG. 3 shows scatter plots of % MAC (% metabolically active cells) of A431NS cell growth for mixtures containing various antibodies. Each dot represents the average of six test wells. The median % MAC for all mixtures containing the individual antibodies is also shown. The dotted line indicates the level where there is no effect on A431NS cell growth.

FIG. 4 shows, at the top, a bar graph showing average % MAC with SEM of the 20 antibody mixtures with the highest efficacy, and at the bottom a scatter plot of % MAC of A431NS cell growth for all mixtures containing particular antibodies in the final group. Each dot represents the average of six test wells. The median % MAC for all antibody mixtures is also shown. The dotted line indicates the level where there is no effect on A431NS cell growth.

FIG. 5 shows, at the top, a bar graph showing average % MAC with SEM of the antibody 20 mixtures with the highest efficacy. At the bottom is shown a scatter plot of % MAC of A431NS cell growth for all 2-mixes containing antibodies in the final group. Each dot represents the average of six test wells. The median % MAC for all antibody mixtures is also shown. The dotted line indicates the level where there is no effect on A431NS cell growth.

### DETAILED DESCRIPTION OF THE INVENTION

### Definitions

By the term “chemical entity” as used herein is meant a chemical compound or a combination of two or more chemical compounds, in which combination the stoichiometric ratio between said two or more chemical compounds is fixed at a constant value.

The term “mixing 2 or more of n samples in all possible combinations” as used herein refers to producing all possible combinations of the n samples that have a pre-defined number of chemical entities in each mixture. For example, in cases where three samples (i.e. three different chemical entities) are mixed in all possible combinations, all possible mixtures comprising three different parts of any of the n samples are produced. This includes mixtures comprising one part of each of three different samples (i.e. mixtures containing three different chemical entities) as well as mixtures comprising two parts of one sample (one chemical entity) together with one part of a different sample (a different chemical entity) and mixtures comprising three parts of a single sample (i.e. containing a single chemical entity). Mathematically the number of combinations can be described as:

$$\frac{( n + k - 1 ) !}{k ! ( n - 1 ) !}$$

where n is the number of samples to be tested and k is the number of samples to be mixed in each mixture.

The number of mixtures thus depends on the number of samples to be tested and the number of samples to be mixed together in each mixture. If, for example, 4 samples are to be tested in mixtures comprising 3 samples, then the number of combinations equals:

$$\frac{( 4 + 3 - 1 ) !}{3 ! ( 4 - 1 ) !}$$

corresponding to 20 combinations.

Designating said four samples A, B, C and D, the following 20 combinations are obtained:

| | | | |
|---|---|---|---|
| A + A + A | B + B + B | C + C + C | D + D + D |
| A + A + B | B + B + C | C+ C + D | |
| A + A + C | B + B + D | C + D + D | |
| A + A + D | B + C + C | | |
| A + B + B | B + C + D | | |
| A + B + C | B + D + D | | |
| A + B + D | | | |
| A + C + C | | | |
| A + C + D | | | |
| A + D + D | | | |

The term “polyclonal protein” or “polyclonality” as used herein refers to a protein composition comprising different but homologous protein molecules, preferably selected from the immunoglobulin superfamily. Thus, each protein molecule is homologous to the other molecules of the composition, but also contains at least one stretch of variable polypeptide sequence that is characterized by differences in the amino acid sequence between the individual members of the polyclonal protein. Known examples of such polyclonal proteins include antibody or immunoglobulin molecules, T cell receptors and B cell receptors. A polyclonal protein may consist of a defined subset of protein molecules defined by a common feature such as the shared binding activity towards a desired target, e.g. a polyclonal antibody exhibiting binding specificity towards a desired target antigen.

The term “antibody” describes a functional component of serum and is often referred to either as a collection of molecules (antibodies or immunoglobulins, fragments, etc.) or as one molecule (the antibody molecule or immunoglobulin molecule). An antibody molecule is capable of binding to or reacting with a specific antigenic determinant (the antigen or the antigenic epitope), which in turn may lead to induction of immunological effector mechanisms. An individual antibody molecule is usually regarded as monospecific, and a composition of antibody molecules may be monoclonal (i.e., consisting of identical antibody molecules) or polyclonal (i.e., consisting of different antibody molecules reacting with the same or different epitopes on the same antigen or on distinct, different antigens).

The distinct and different antibody molecules constituting a polyclonal antibody may be termed “members”. Each antibody molecule has a unique structure that enables it to bind specifically to its corresponding antigen, and all natural antibody molecules have the same overall basic structure of two identical light chains and two identical heavy chains. Antibodies are also known collectively as immunoglobulins. The term antibody as used herein is used in the broadest sense and covers intact antibodies, chimeric, humanized, fully human and single chain antibodies, as well as binding fragments of antibodies, such as Fab, Fab′, (Fab′)₂, Fv fragments or scFv fragments, as well as multimeric forms such as dimeric IgA molecules or pentavalent IgM.

The term “polyclonal antibody” describes a composition of different (diverse) antibody molecules which are capable of binding to or reacting with several different specific antigenic determinants on the same or on different antigens. Usually, the variability of a polyclonal antibody is located in the so-called variable regions of the polyclonal antibody, in particular in the CDR regions. When a member of a polyclonal antibody is stated to bind to an antigen, this refers to binding with a binding constant below 100 nM, preferably below 10 nM, even more preferred below 1 nM.

A “2-mix” or “3-mix” as used herein in refers to mixtures containing 2 or 3, respectively, different chemical entities, for example 2 or 3 different antibodies.

The term “immunoglobulin” is commonly used as a collective designation of the mixture of antibodies found in blood or serum, but may also be used to designate a mixture of antibodies derived from other sources, or may be used synonymously with the term “antibody”. The classes of human antibody molecules are: IgA, IgD, IgE, IgG and IgM. Members of each class are said to be of the same isotype. IgA and IgG isotypes are further subdivided into subtypes. The subtypes of IgA and IgG commonly refer to IgA1 and IgA2, and IgG1, IgG2, IgG3 and IgG4, respectively.

The terms “cognate VH and VL coding pair” or “cognate pairs of VH and VL sequences” describe an original pair of VH and VL coding sequences contained within or derived from the same cell. Thus, a cognate VH and VL pair represents the VH and VL pairing originally present in the donor from which such a cell is derived. The term “an antibody expressed from a VH and VL coding pair” indicates that an antibody or an antibody fragment is produced from a vector, plasmid or similar containing the VH and VL coding sequences. When a cognate VH and VL coding pair is expressed, either as a complete antibody or as a stable fragment thereof, they preserve the binding affinity and specificity of the antibody originally expressed from the cell they are derived from. A composition of cognate pairs is also termed a repertoire of cognate pairs, and may be kept individually or pooled.

The term “epitope” is commonly used to describe a site on an antigen to which the antibody will bind. An antigen is a substance that stimulates an immune response, e.g. a toxin, virus, bacteria, protein or DNA. An antigen often has more than one epitope, unless it is very small. Antibodies binding to different epitopes on the same antigen can have varying effects on the activity of the antigen they bind, depending on the location of the epitope. An antibody binding to an epitope in an active site of the antigen may block the function of the antigen completely, whereas another antibody binding at a different epitope may have no or little effect on the activity of the antigen. Such antibodies may, however, still activate complement or other effector mechanisms and thereby result in the elimination of the antigen.

A “receptor” is a protein molecule, embedded in either the plasma membrane or cytoplasm of a cell, to which a mobile signaling (or “signal”) molecule may attach. A molecule which binds to a receptor is called a “ligand,” and may be a protein, a peptide, a neurotransmitter, a hormone, a pharmaceutical drug or a toxin. When such binding occurs, the receptor undergoes a conformational change, which ordinarily initiates a cellular response. However, some ligands merely block receptors without inducing any response (e.g. antagonists). Ligand-induced changes in receptors result in physiological changes which constitute the biological activity of the ligands. A “soluble receptor” is a receptor without its transmembrane region. The soluble receptor can bind its ligand in the same way as the membrane bound receptor but cannot signal.

“Synergy” is the term used to describe a situation where the final outcome of a system is greater than the sum of its parts. The opposite of synergy is antagonism, the phenomenon where two agents in combination have an overall effect that is less than that predicted from their individual effects. Synergy can also mean: a) a mutually advantageous conjunction where the whole is greater than the sum of the parts; b) a dynamic state in which combined action is favored over the sum of individual component actions; c) behavior of whole systems unpredicted by the behavior of their parts taken separately; or d) the cooperative action of two or more stimuli or drugs. In the present context, “synergy” generally refers to the latter definition, i.e. where total effect of a combination of two or more drugs, e.g. two or more antibodies, on a given condition is greater than the sum of the individual effects.

### DETAILED DESCRIPTION

The invention will now be described in more detail as to how the method is performed, including the types of functional assays that may be used to test the chemical compounds and the types of chemical entities that may be tested in the method.

### DESCRIPTION OF THE METHODS OF THE INVENTION

The method according to the present invention is designed for identifying and selecting chemical entities contributing to and/or possessing a functional effect, in order to obtain a mixture comprising at least 2 chemical entities possessing a desired functional effect. The method is particularly suitable for identifying new combinatorial drugs, in particular recombinant polyclonal antibodies, since it allows identification of synergistic or combinatorial effects that may exist when two, three or more chemical compounds are combined in one drug. The method may, however, also find use in the development of other products comprising at least two active chemical compounds showing either a desired synergistic effect or two different functional effects, for example in the case of agricultural chemicals or cosmetic compounds.

The method according to the present invention comprises at least seven steps, namely steps a to g listed above. In step a, a number of samples (n samples) is provided. Each of said samples comprises one chemical entity to be tested. In step b, at least 2 of said n samples are mixed in all possible combinations to result in a first set of mixtures to be tested. In this way, a specific number of mixtures are systematically obtained, and it is ensured that all possible mixtures are investigated. In step c, each of the first set of mixtures is subjected to a functional assay capable of measuring a functional parameter in order to identify chemical entities contributing to the functional effect. In step d, information from the functional assay is used to select a number of samples each comprising a chemical entity contributing to the desired functional effect, where the number of samples selected in this step (m) is smaller than the original number of samples (n). The basic method of the invention comprises four additional steps e-g. In step e, two or more of the m samples are mixed in all possible combinations in order to obtain a second set of mixtures to be tested. In step f, the second set of mixtures is subjected to a functional assay capable of measuring a functional parameter in order to identify chemical entities contributing to the functional effect. Information from this functional assay is then used to select a mixture possessing the desired functional effect in step g. The functional assay performed in step f will typically be the same as the functional assay performed in step c. However, it is also possible to perform two different functional assays in these two steps. Another alternative would e.g. be to perform the same functional assay in steps c and f, but to perform a different functional assay in one or more further rounds of mixing, assaying and selection. It is of course also possible to perform two or more different functional assays at any given assay step, and to base the selection on these two or more assays rather than on a single assay.

In the above described method, n different samples are tested with regard to a functional effect. These n samples may either equal the total number of samples to be tested or the n samples may constitute a sub-group originating from a larger pool of samples which has been divided into a number of sub-groups before the samples are mixed and subjected to the basic method steps a-g.

More specifically, in cases where only a limited number of samples are to be tested a method only comprising the above mentioned seven steps, i.e. steps a to g, is performed, because the number of mixtures to be tested is sufficiently limited to allow all of them to be subjected to the functional assay without undue burden. However, if a large number of samples are to be tested, then the number of all possible combinations of mixtures to be tested will also be large, and an excessive amount of work may be required to measure the functional effect. In order to rationalize the method of the present invention in such cases, another systematic strategy may be used to select the chemical entities of interest.

Hence, in cases where a large number of samples are to be tested and/or where there are a large number of samples in each mixture, it may be beneficial to initially divide the number of samples to be tested into smaller subgroups each comprising n samples, after which 2 or more of said n samples in each subgroup are mixed in all possible combinations in step b before subjecting the mixtures to the functional assay in step c.

However, due to the fact that only the samples in each subgroup will have been mixed in all possible combinations, the most optimal mixture may not have been tested using this approach, because at this point not all possible mixtures of all samples to be tested have been mixed and subjected to the functional assay. Further information on combinations that were not tested in the first round (steps a-d) will typically be obtained by means of a new round of mixing, testing by a functional assay and selection as set forth in steps e-g. In this case, the m samples which are selected preferably originate from different subgroups in order for new mixtures to be formed. Different approaches for selecting samples will be discussed below.

After selecting the m samples, new mixtures are formed by mixing at least 2 of said m samples in all possible combinations in step (e). In this way new mixtures are obtained, which subsequently are subjected to the functional assay in step (f), where a functional parameter is measured in order to identify chemical entities possessing or contributing to the functional effect.

In some cases the number of samples (n samples) provided for in step a is very large, and in such cases it may be beneficial to select the number of samples to be tested in multiple steps, so that the number of mixtures on which the functional assay must be performed is limited in the most rational way. This is most appropriately done by repeating method steps (d), (e) and (f). In this way the samples selected in step c are divided into sub-pools each comprising m samples and on which the method steps (d), (e) and (f) are performed. In each repetition the total number of samples selected is reduced. A skilled person will appreciate that the method steps performed on samples from different pools may be performed in parallel or sequentially.

The method of the invention includes testing of mixtures containing 2 samples. However, preferably the method is performed by mixing 3, or optionally more than 3, of the n samples in step b in all possible combinations. It is also preferred to mix 3, or optionally more than 3, of the m samples in step (e). A skilled person will recognize that mixtures obtained by mixing more than 3 samples, for example 4, 5, 6 or 7 samples or even 8, 9, 10 or more samples, also are within the scope of the method of the present invention.

In some cases the goal may be to identify a mixture comprising a relatively large number of different chemical entities. An example of such a mixture is a recombinant polyclonal antibody designed to contain e.g. 5-15 different individual antibodies. In such cases, the process may be rationalized by initially testing mixtures only comprising a small number of different chemical entities, e.g. three different antibodies or other chemical entities being tested, and then subsequently forming new mixtures for testing and selection in steps e-g by mixing two or more of the selected mixtures and then subjecting the new mixtures to the functional assay. Thus, for the second round of mixing, testing and selection, a mixture of e.g. three different chemical entities selected on the basis of the initial functional assay (step c) can be considered to be a “sample” to be mixed in step e, such that the samples that are subjected to the functional assay in step f will contain a larger number of different chemical entities than the original mixtures that were assayed in step c. This variation of the basic method of the invention may be defined by the following steps subsequent to step c:

d1) selecting m1 mixtures possessing the desired functional effect;

e1) mixing 2, 3, 4 or 5 of said m1 mixtures selected in step d1 in all possible combinations;
f1) subjecting said mixtures of step e1 to a functional assay capable of measuring a functional parameter in order to identify mixtures contributing to a functional effect; and
g1) selecting from the mixtures of step e1 a second mixture possessing the desired functional effect.

The basic method of the invention set forth in steps a-g may thus be varied as needed, e.g. depending on the total number of samples to be tested (n) and the number of different chemical entities desired in the final mixture. It will be understood that the basic method comprises at least two rounds of mixing, assaying and selecting, i.e. one round comprising steps b, c and d, and another round comprising steps e, f and g. Depending on the circumstances, however, one or both of these rounds may be repeated one or more times.

If a mixture comprising a very large number of chemical entities is aimed at, e.g. a recombinant polyclonal antibody containing up to about 25 different individual antibodies, then the method may include three more method steps, namely steps h, i, and j. In step h, 2, 3, 4 or 5 of the selected mixtures obtained in step g1 are mixed, and in the subsequent step i said mixtures are subjected to a functional assay capable of measuring a functional parameter in order to identify mixtures possessing a functional effect. In the last step, step j, a third mixture possessing the desired functional effect is selected.

It will be within the skill of an ordinary practitioner to expand upon the method by including further steps or further rounds of the basic procedure of the type outlined above.

In order to perform a suitable identification of samples comprising a chemical entity possessing or contributing to the functional effect, it may be preferred to only compare samples in which any of the chemical entities being investigated appears only once. For example, in the case of antibody 3-mixes, it may be desirable to only compare samples that contain three different antibodies (i.e. excluding samples containing two parts of one antibody and one part of another, or three parts of a single antibody). As will be discussed later, the present invention also provides a method by which an optimal stoichiometric ratio between chemical entities may be identified, and hence in order to exclude any contribution to the functional effect due to a chemical entity being present at different concentrations, it may be desired to compare only mixtures in which the concentration of the different chemical entities is identical. Using this approach, it is preferred that any chemical entity appears only once in the mixtures which are prepared in step e1 and in step h, respectively.

Many different approaches can be used when selecting samples comprising a chemical entity which possesses or contributes to the functional effect. In one approach, the identification as to whether a chemical entity A possesses or contributes to the functional effect is performed by comparing the functional effect of a mixture comprising chemical entity A with the functional effect of at least one mixture not comprising chemical entity A. For example, in the case of mixtures containing three chemical entities, the identification as to whether a chemical entity A possesses or contributes to the functional effect may be performed by mixing three samples comprising the chemical entity A and/or a chemical entity B in all possible combinations and comparing the functional effect of mixtures comprising e.g. one part of chemical entity A and two parts of chemical entity B, and two parts of chemical entity A and one part of chemical entity B, with the functional effect of a mixture comprising three parts of chemical entity B.

In another approach, the identification as to whether a chemical entity A possesses or contributes to the functional effect is performed by comparing the functional effect of a mixture comprising chemical entity A together with other chemical entities with the functional effect of a mixture only comprising chemical entity A.

In yet another approach, the identification as to whether a chemical entity A possesses the functional effect is performed by comparing the functional effect of a mixture comprising chemical entity A with a reference value. Preferably, this reference value is a predetermined value. The identified functional effect of the mixture comprising chemical entity A must be either higher than, equal to or less than the predetermined value in order for chemical entity A to be defined as possessing or contributing to the functional effect. In some cases, the reference value may be an interval within which the identified functional effect of the mixture comprising chemical entity A must lie in order for chemical entity A to be defined as possessing or contributing to the functional effect. In other cases the reference value may be an average value of any parameter measured by performing an analytical assay, such as the average value of all values measured when subjecting the mixtures to the functional assay.

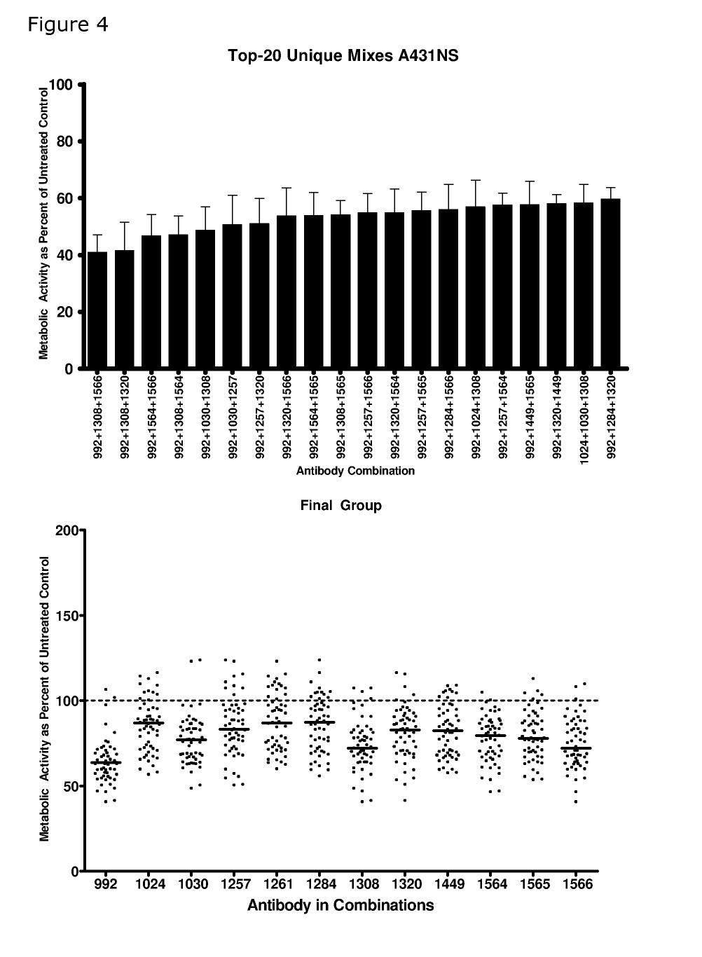

One preferred approach to identify chemical entities possessing or contributing to the functional effect is to identify the chemical entities which appear most frequently in the mixtures possessing the functional effect. By establishing the chemical composition of the mixtures showing the highest potency and efficacy and by identifying which chemical entities that appear most frequently in those mixtures, a good indication as to whether and how often a certain chemical entity contributes to the functional effect can be obtained. This approach is used in Example 3 below, where the results of the functional assay show that antibody 992 is found in 19 out of the 20 most efficient mixtures (see FIG. 4), and hence it can be concluded that this antibody works very well in combination with other anti-EGFR antibodies.

The number of samples to be tested may vary markedly depending on the type of combinatorial drug searched for, that is whether the chemical entities to be investigated are of the same type (for example antibodies) or whether the chemical entities are of different types (for example an antibody combined with a small molecule drug). Preferably, n is an integer having a value of 3 or more, for example between 3 and 1440, preferably between 3 and 360, such as between 3 and 120, or even more preferred between 3 and 24, such as between 3 and 12.

Depending on the number of starting samples, the number of selected samples (the m samples) in step (d) may also vary markedly. It is, however, preferred that m is an integer having a value of 3 or more, such as between 3 and 720, preferably between 3 and 360, such as between 3 and 120, or even more preferred between 3 and 24, such as between 3 and 12.

In the present invention the functional effect of a chemical entity or a mixture of chemical entities is identified in a functional assay by measuring a functional parameter which may be altered due to the presence of a chemical entity as compared to the parameter in the absence of said chemical entity. This functional parameter to be measured may, for example, be any one of:
exertion of a physical effect—this can e.g. be emission of fluorescence or luminescence, or absorbance of light or other electromagnetic radiation;
binding to a ligand or antigen—typical examples are binding of receptor molecules or antibodies;
exertion of catalytic activity, such as enzymatic activity;
susceptibility to catalytic activity, such as enzymatic activity;
facilitation of altered transport of an agent across a biological membrane;
facilitation of altered translocation of an agent in the intracellular compartment;
influence on expression of at least one gene in a population of eukaryotic cells—i.e. the function of the compound as an expression regulator (e.g. on the transcription level) can be assayed;
influence on the growth or metabolism of a population of eukaryotic cells -convenient in cases where libraries encoding mutated versions of a growth regulator are screened;
influence on target cells—it is e.g. possible to test for a compound's effects on proliferation, anti-proliferation, differentiation, apoptosis, metabolism or drug sensitivity, all of which may be of relevance when screening for expression products which could e.g. function as anti-cancer drugs;
influence on a pathogenic agent—it is possible to assay for virus neutralisation, binding to virus or killing of virus, and likewise it is possible to assay for binding to bacteria, killing of bacteria, phagocytosis, ADCC, CDC, etc.;
influence on secondary immune effects;
influence on the ability of the compound to be expressed, manufactured or formulated;
influence on stability.

The term “desired functional effect” refers to any desired alteration of a functional parameter. The desired alteration of the functional parameter will obviously depend on the nature of the chemical entities being assayed and the intended in vitro or in vivo effect. Typically, the desired functional effect will be one that indicates that the chemical entities in question may be capable of providing an improved medicament for a particular condition. For example, if the chemical entity to be tested is to be used as an anti-AIDS agent, the desired functional effect could be an increased binding to or neutralization of HIV or an increased killing of HIV-infected cells.

When developing new drugs and drug combinations, one may look for a new formulation possessing a synergistic effect or one may look for a new formulation possessing more than one functional effect. For example, it may be of interest to develop a drug which on the one hand treats cancer and on the other hand reduces side-effects of chemotherapy. As another example, an influenza vaccine that simultaneously combats more than one virus may be of interest.

In such cases, the method according to the present invention may be altered in such a way that the mixtures to be tested are subjected to two or more functional assays, where each functional assay is capable of measuring a functional parameter, in order to measure two or more functional parameters of each mixture independently. These assays may be performed in parallel or in series. The functional parameters to be examined may e.g. be the influence on the growth or metabolism of a population of eukaryotic cells or the influence on target cells.

Any mode of performing the method according to the present invention can be employed. However, in view of the number of mixtures to be made and the number of functional assays to be performed, it is preferred that the mode of operation includes some kind of automation. Therefore, in one mode of operation the method is performed in multiwell plates. These plates are standard equipment in any laboratory and any person skilled in the art would know how to perform experiments using such plates. Preferably, the mixtures are mixed by use of automated liquid handling as this will reduce the amount of work that needs to be done in order to prepare the mixtures to be investigated. Functional assays may also be performed by means of robotics using equipment and methods known in the art.

Another aspect of the present invention provides a method for identifying and selecting the optimal stoichiometric ratio between chemical entities in a mixture comprising at least 2 chemical entities to obtain a desired functional effect. This method is helpful for finding the optimal concentration levels in a combinatorial drug. For instance, it is well-known that when two or more antibodies are present in the same mixture a competition for binding to a specific target is likely to occur. This competition is in part dependent on the concentration of the different antibodies present in the mixture, so that the higher the concentration of a specific antibody, the more likely it is that said antibody will successfully compete for binding to the target. Hence, in order to achieve the optimal synergistic effect of a combinatorial drug, the concentration of each chemical entity as well as the stoichiometric ratio between the different chemical entities is preferably optimised.

The method according to the present invention for identifying and selecting an optimal stoichiometric ratio between chemical entities in a mixture comprises at least five steps. In the first step, step aa, p samples each comprising one chemical entity to be present in the mixture are provided. Next, in step bb, each of said p samples is diluted q times in order to obtain p series of samples each comprising the same chemical entity, but at different concentrations. Thereafter, in step cc, 2 or more of the samples obtained in steps aa and bb are mixed in all possible combinations in order to obtain mixtures to be tested, and then, in step dd, the mixtures obtained in step cc are subjected to a functional assay capable of measuring a functional effect in order to identify the relationship between the measured functional effect and the concentration of the chemical entity in the mixture. In the last step, step ee, a mixture possessing the desired functional effect is selected.

The number of samples provided for in step aa corresponds to the number of different chemical entities present in the mixture to be investigated. Hence, if a combinatorial drug comprising three different chemical entities is aimed at, then p equals 3. Preferably, however, p is an integer having a value of 2 or more, more preferred having a value between 2 and 24, even more preferred between 2 and 12.

In principle, in step bb the samples may be diluted by any suitable factor as known in the art. Preferably, however, the samples are diluted by a factor 2, 5, 10, 20, 50 or 100. Any sample may be diluted a number of times in order to obtain a series of samples in which each sample has a different concentration. Preferred methods are those in which the samples are diluted 1, 2, 3, 4 or 5 times.

In yet another aspect of the present invention, a mixture identified to be optimal according to a method of the invention may be used as a medicament or for the manufacture of a medicament. However, as mentioned above, the mixtures selected and identified according to the methods of the present invention may not only be suitable for drugs but also for other products comprising two or more chemical compounds such as an agricultural or cosmetic product.

Examples of Compounds that May be Selected According to the Invention

In general, any chemical compound known to have a beneficial effect when administered to the human and animal body will be of interest to test in the methods according to the present invention. However, compounds which are not known to possess any beneficial effect, e.g. a pharmaceutical effect, may also be tested in order to discover an unknown effect or perhaps a synergistic effect that may be revealed when tested in combination with one or more other chemical compounds.

In the method according to the present invention the compounds comprised in any of the chemical entities to be tested may be any chemical compound of interest for the treatment or prophylaxis of any medical condition, or for the alleviation of a medical condition or simply for the well-being of a human being or an animal. However, preferably, the chemical compounds to be tested in the methods according to the present invention are selected from the group consisting of antibodies, antibiotics, anti-cancer agents, anti-AIDS agents, anti-growth factors, antiviral agents, biologics (including e.g. soluble receptors, cytokines and other proteins), RNAi's, vaccines and mixtures thereof.

In cases where the chemical compound comprised in the chemical entities to be tested is an antibody, the mixtures subjected to the functional assays may be a combination of two or more antibodies, or a combination in which at least one antibody is combined with one or more other chemical compounds, for example selected from the group consisting of antibiotics, antiviral agents, anti-cancer agents, anti-autoimmune disease agents and RNAi's. Preferably, the compounds comprised in the chemical entities to be tested are antibodies, and more preferred, the compounds comprised in the chemical entities to be tested are monoclonal antibodies. The invention is particularly suitable for testing numerous combinations of monoclonal antibodies in order to identify an optimal combination of monoclonal antibodies that may be produced as a recombinant polyclonal antibody or a cocktail of monoclonal antibodies.

### Antibodies

One group of compounds that can be used in the methods of the present invention includes antibodies or functional equivalents thereof specifically recognising and binding an epitope.

The antibody or functional equivalent thereof may be any antibody known in the art, for example a monoclonal antibody derived from a mammal or a synthetic antibody, such as a single chain antibody or hybrids comprising antibody fragments. In addition, functional equivalents of antibodies may be antibody fragments, in particular epitope binding fragments. Furthermore, antibodies or functional equivalents thereof may be small molecules that mimic an antibody. Naturally occurring antibodies are immunoglobulin molecules consisting of heavy and light chains. In preferred embodiments of the invention, the individual antibodies are monoclonal antibodies, and the invention is used to identify mixtures of monoclonal antibodies suitable for use in an recombinant antibody “cocktail” or a recombinant polyclonal antibody.

The antibodies according to the present invention may also be bispecific antibodies, i.e. antibodies specifically recognising two different epitopes. Bispecific antibodies may in general be prepared starting from monoclonal antibodies, or by using recombinant technologies. Antibodies according to the present invention may also be tri-specific antibodies.

Functional equivalents of antibodies may in one preferred embodiment be a fragment of an antibody, preferably an antigen binding fragment or a variable region. Examples of antibody fragments useful with the present invention include Fab, Fab′, F(ab′)₂ and Fv fragments. Papain digestion of antibodies produces two identical antigen binding fragments, called the Fab fragment, each with a single antigen binding site, and a residual “Fc” fragment. Pepsin treatment yields an F(ab′)₂ fragment that has two antigen binding fragments which are capable of cross-linking antigen, and a residual other fragment (which is termed pFc′). Such fragments may also be produced recombinantly by inserting the relevant parts of the heavy and light chain coding regions into an expression vector. Additional fragments can include diabodies, linear antibodies, single-chain antibody molecules, and multispecific antibodies formed from antibody fragments. As used herein, “functional fragment” with respect to antibodies refers to Fv, F(ab) and F(ab′)₂ fragments. Preferred antibody fragments retain some or essential all the ability of an antibody to selectively binding with its antigen.

In one embodiment the antibody is a single chain antibody, defined as a genetically engineered molecule containing the variable region of the light chain and the variable region of the heavy chain, linked by a suitable polypeptide linker as a genetically fused single chain molecule. Such single chain antibodies are also referred to as “single-chain Fv” or “scFv” antibody fragments. Generally, the Fv polypeptide further comprises a polypeptide linker between the VH and VL domains that enables the scFv to form the desired structure for antigen binding. Using appropriate linkers, single chain Fab fragments can also be prepared.

### Isolation and Selection of Variable Heavy Chain and Variable Light Chain Coding Pairs

Antibodies can be produced by a variety of techniques, including conventional monoclonal antibody methodology, e.g. the standard somatic cell hybridization technique of Kohler and Milstein, Nature 256:495 (1975). Other techniques for producing monoclonal antibodies can be employed, e.g. viral or oncogenic transformation of B-lymphocytes or phage display techniques using libraries of human antibody genes. One preferred method for isolating fully human antibodies suitable for production as monoclonal or polyclonal antibodies is the Symplex™ technology (Meijer et al., J Mol. Biol. 2006 May 5; 358(3):764-72; and WO 2005/042774), which is able to generate an antibody repertoire with high complexity and diversity, while maintaining the original heavy and light chain pairing and avoiding the cell culturing step necessary with hybridoma technology.

The process of generating antibodies involves the isolation of sequences coding for variable heavy chains (VH) and variable light chains (VL) from a suitable source, thereby generating a repertoire of VH and VL coding pairs. Generally, a suitable source for obtaining VH and VL coding sequences is lymphocyte containing cell fractions such as blood, spleen or bone marrow samples from one or more individuals that have reacted to a relevant target with a suitable immune response. Preferably, lymphocyte containing fractions are collected from humans or transgenic animals with human immunoglobulin genes that have reacted to the relevant target. The collected lymphocyte containing cell fraction may be enriched further to obtain a particular lymphocyte population, e.g. B lymphocytes. Preferably, the enrichment is performed using magnetic bead cell sorting (MACS) and/or fluorescence activated cell sorting (FACS), taking advantage of lineage-specific cell surface marker proteins, for example for B cells and/or plasma cells. Preferably, the lymphocyte containing cell fraction is enriched with respect to B cells and/or plasma cells. Even more preferred, cells with high CD19 and CD38 expression and intermediate CD45 expression are isolated from blood. These cells are sometimes termed circulating plasma cells, early plasma cells or plasma blasts, referred to for simplicity as plasma cells in the present application.

In general, the isolation of VH and VL coding sequences can be performed in any manner in which the VH and VL coding sequences are combined in a vector to generate a library of VH and VL coding sequence pairs. In the classical manner, the VH and VL coding sequences are combined randomly in a vector to generate a combinatorial library of VH and VL coding sequence pairs. The isolation of VH and VL coding sequences can e.g. be performed by phage display and hybridoma technology, including use of transgenic animals (see further below).

In the present invention it is preferred to maintain the original pairing of heavy and light chain to maintain the potency and affinity of antibodies generated by a natural immune response in a donor—whether it be a human or an animal. This involves the maintenance of the VH and VL pairing originally present in the donor, thereby generating a repertoire of sequence pairs where each pair encodes a variable heavy chain (VH) and a variable light chain (VL) corresponding to a VH and VL pair originally present in an antibody produced by the donor from which the sequences are isolated. This is also termed a cognate pair of VH and VL encoding sequences and the antibody is termed a cognate antibody. In one preferred embodiment, the VH and VL coding pairs of the present invention, combinatorial or cognate, are obtained from human donors, and therefore the sequences are completely human. Alternatively, the VH and VL coding pairs may be obtained from a transgenic animal capable of generating human antibodies, for example using the HuMAb-Mouse® technology (Medarex) or the XenoMouse® technology (Abgenix/Amgen).

There are several different approaches for the generation of cognate pairs of VH and VL encoding sequences. One approach involves the amplification and isolation of VH and VL encoding sequences from single cells sorted out from a lymphocyte-containing cell fraction. The VH and VL encoding sequences may be amplified separately and paired in a second step or they may be paired during the amplification (Coronella et al. 2000 Nucleic Acids Res. 28: E85; Babcook et al 1996 PNAS 93: 7843-7848). An alternative approach involves in-cell amplification and pairing of the VH and VL encoding sequences (Embleton et al. 1992. Nucleic Acids Res. 20: 3831-3837; Chapal et al. 1997 BioTechniques 23: 518-524).

In order to obtain a repertoire of VH and VL encoding sequence pairs which resemble the diversity of VH and VL sequence pairs in the donor, a high-throughput method with as little scrambling (random combination) of the VH and VL pairs as possible is preferred, e.g. as described in Meijer et al (3 Mol. Biol. 2006 May 5; 358(3):764-72) and in WO 2005/042774 (hereby incorporated by reference).

Preferably, a repertoire of VH and VL coding pairs in which the member pairs mirror the gene pairs responsible for the humoral immune response upon challenge with a target is generated according to a method comprising the steps: i) providing a lymphocyte-containing cell fraction from one or more donors having reacted to a relevant target; ii) optionally enriching B cells or plasma cells from said cell fraction; iii) obtaining a population of isolated single cells by distributing cells from said cell fraction individually into a plurality of vessels; iv) amplifying and effecting linkage of the VH and VL coding pairs in a multiplex overlap extension RT-PCR procedure using a template derived from said isolated single cells and v) optionally performing a nested PCR of the linked VH and VL coding pairs. Prior to performing the methods of the present invention, the isolated cognate VH and VL coding pairs are preferably subjected to a screening procedure as described below.

Once the VH and VL sequence pairs have been generated, a screening procedure to identify sequences encoding VH and VL pairs with binding reactivity towards a relevant target is performed. The screening for binders to a target is generally performed with immunodetection assays such as FACS, ELISA, FLISA and/or immunodot assays.

The VH and VL pair encoding sequences selected in the screening are generally subjected to sequencing and analyzed with respect to diversity of the variable regions. In particular, the diversity in the CDR regions is of interest, but also the VH and VL family representation is of interest. Based on these analyses, sequences encoding VH and VL pairs representing the overall diversity of the agent-binding antibodies isolated from one or more donors are selected. Preferably, sequences with differences in all the CDR regions (CDRH1, CDRH2, CDRH3 and CDRL1, CDRL2 and CDRL3) are selected. If there are sequences with one or more identical or very similar CDR regions which belong to different VH or VL families, these are also selected. The selection of VH and VL sequence pairs can also be performed based on the diversity of the CDR3 region of the variable heavy chain. During the priming and amplification of the sequences, mutations may occur in the framework regions of the variable region. Preferably, such errors are corrected in order to ensure that the sequences correspond completely to those of the donor, e.g. such that the sequences are completely human in all conserved regions such as the framework regions of the variable region.

When it is ensured that the overall diversity of the collection of selected sequences encoding VH and VL pairs is highly representative of the diversity seen at the genetic level in a humoral response to a challenge with a distinct target, it is expected that the overall specificity of antibodies expressed from a collection of selected VH and VL coding pairs also will be representative with respect to the specificity of the antibodies produced in the challenged donors.

### Antibodies Generated Using Transgenic Animals and Hybridomas

In one embodiment, monoclonal antibodies can be generated using transgenic or transchromosomal animals carrying parts of the human immune system rather than the mouse system. These include transgenic and transchromosomic mice such as HuMAb® mice, the XenoMouse® and KM mice, and are collectively referred to herein as “transgenic mice.”

The HuMAb-Mouse® contains a human immunoglobulin gene miniloci that encodes unrearranged human heavy (μ and γ) and κ light chain immunoglobulin sequences, together with targeted mutations that inactivate the endogenous μ and κ chain loci (Lonberg, N. et al. (1994) Nature 368 (6474):856-859). Accordingly, the mice exhibit reduced expression of mouse IgM or κ and in response to immunization, the introduced human heavy and light chain transgenes undergo class switching and somatic mutation to generate high affinity human IgG,κ monoclonal antibodies (Lonberg, N. et al. (1994), supra; reviewed in Lonberg, N. (1994) Handbook of Experimental Pharmacology 113:49-101; Lonberg, N. and Huszar, D. (1995) Intern. Rev. Immunol. Vol. 13:65-93, and Harding, F. and Lonberg, N. (1995) Ann. N.Y. Acad. Sci. 764:536-546). The preparation of HuMAb® mice is described in detail in Taylor, L. et al. (1992) Nucleic Acids Research 20:6287-6295; Chen, J. et al. (1993) International Immunology 5:647-656; Tuaillon et al. (1994) J. Immunol. 152:2912-2920; Lonberg et al., (1994) Nature 368(6474):856-859; Lonberg, N. (1994) Handbook of Experimental Pharmacology 113:49-101; Taylor, L. et al. (1994) International Immunology 6:579-591; Lonberg, N. and Huszar, D. (1995) Intern. Rev. Immunol. Vol. 13:65-93; Harding, F. and Lonberg, N. (1995) Ann. N.Y. Acad. Sci. 764:536-546; Fishwild, D. et al. (1996) Nature Biotechnology 14:845-851. See further, U.S. Pat. Nos. 5,545,806; 5,569,825; 5,625,126; 5,633,425; 5,789,650; 5,877,397; 5,661,016; 5,814,318; 5,874,299; and 5,770,429; all to Lonberg and Kay, as well as U.S. Pat. No. 5,545,807 to Surani et al.; WO 98/24884, WO 94/25585, WO 93/1227, WO 92/22645, WO 92/03918 and WO 01/09187.

The KM mouse contains a human heavy chain transchromosome and a human kappa light chain transgene. The endogenous mouse heavy and light chain genes also have been disrupted in the KM mice such that immunization of the mice leads to production of human immunoglobulins rather than mouse immunoglobulins. Construction of KM mice and their use to raise human immunoglobulins is described in detail in WO 02/43478.

To generate human monoclonal antibodies, transgenic or transchromosomal mice containing human immunoglobulin genes (e.g., HCO12, HCO7 or KM mice) can be immunized with an enriched preparation of antigen and/or cells expressing the antigen, as described, for example, by Lonberg et al. (1994), supra; Fishwild et al. (1996), supra, and WO 98/24884. Alternatively, mice can be immunized with DNA encoding the antigen. Preferably, the mice will be 6-16 weeks of age upon the first infusion. For example, an enriched preparation (5-50 μg) of the antigen can be used to immunize the HuMAb® mice intraperitoneally. In the event that immunizations using a purified or enriched preparation of the antigen do not result in antibodies, mice can also be immunized with cells expressing the antigen, e.g., a cell line, to promote immune responses.

To generate hybridomas producing monoclonal antibodies, splenocytes and lymph node cells from immunized mice can be isolated and fused to an appropriate immortalized cell line, such as a mouse myeloma cell line. The resulting hybridomas can then be screened for the production of antigen-specific antibodies. For example, single cell suspensions of splenic lymphocytes from immunized mice can be fused to SP2/0 nonsecreting mouse myeloma cells (ATCC, CRL 1581) with 50% PEG (w/v). Cells can be plated at approximately 1×10⁵ per well in flat bottom microtiter plate, followed by a two week incubation in selective medium containing besides usual reagents 10% fetal Clone Serum, 5-10% origin hybridoma cloning factor (IGEN) and 1×HAT (Sigma). After approximately two weeks, cells can be cultured in medium in which the HAT is replaced with HT. Individual wells can then be screened by ELISA for human kappa-light chain containing antibodies and by FACS analysis. Once extensive hybridoma growth occurs, medium can be observed usually after 10-14 days. The antibody secreting hybridomas can be replated, screened again, and if still positive for human IgG, monoclonal antibodies can be subcloned at least twice by limiting dilution. The stable subclones can then be cultured in vitro to generate antibody in tissue culture medium for characterization.

Human antibodies of the invention also can be produced in a host cell transfectoma using, for example, a combination of recombinant DNA techniques and gene transfection methods as is well known in the art, see e.g. Morrison, S. (1985) Science 229:1202.

In a particular embodiment, it may be of interest to use the methods of the invention in order to identify advantageous combinations of a) one or more monoclonal antibodies, preferably at least two monoclonal antibodies, and b) at least one additional therapeutic agent that provides a synergistic or otherwise advantageous functional effect in combination with the one or more antibodies of a). For example, when the antibodies are for preventing or treating a bacterial infection, it may be advantageous to identify optimal combinations of two or more monoclonal antibodies together with at least one non-antibody antibacterial agent (see e.g. below regarding antibiotics). Similarly, when the antibodies are for the prevention or treatment of cancer or tumor growth, it may be advantageous to identify optimal combinations of two or more such anti-cancer monoclonal antibodies together with at least one non-antibody anti-cancer agent (see below regarding anti-cancer agents). The same applies when the antibodies are directed at prevention or treatment of AIDS or another viral disease, in which case it may be advantageous to identify optimal combinations of two or more such anti-HIV or other antiviral monoclonal antibodies together with at least one non-antibody anti-HIV agent or antiviral agent, respectively (see below regarding anti-HIV and other antiviral agents). It will be clear to persons skilled in the art that this same approach, i.e. combining one or more monoclonal antibodies, and preferably at least two monoclonal antibodies, with at least one non-antibody agent directed to prevention or treatment of the same condition as the antibodies (or optionally directed to an associated condition) may be used in other indications as well, for example as a combination of monoclonal antibodies directed against an autoimmune disease together with a known or novel non-antibody agent directed against the same autoimmune disease.

### Antibiotics

Antibiotics may be defined as molecules that kill or stop the growth of microorganisms including both bacteria and fungi. Antibiotics that kill bacteria are also called bacteriocidals whereas antibiotics that stop the growth of bacteria are also called bacteriostatics.

Antibiotics that could be of interest to test for their functional effect when incorporated in combinatorial drugs include β-lactam antibiotics, such as penicillins (e.g. amoxicillin), cephalosporins, carbapenems, monobactams, etc, tetracyclines, such as tetracycline, macrolide antibiotics, such as erythromycin, aminoglycosides, such as gentamicin, tobramycin and amikacin, quinolones, such as ciprofloxacin, cyclic peptides, such as vancomycin, streptogramins and polymyxins, lincosamides, such as clindamycin, oxazolidinoes, such as linezolid, and sulfa antibiotics, such as sulfisoxazole.

### Anti-Cancer Agents

Anti-cancer agents (also known as chemotherapeutic drugs) may be defined as drugs that impair mitosis (cell division), and hence effectively target fast-dividing cells. As these drugs cause damage to cells they are also termed cytotoxic. Some of these drugs cause cells to undergo apoptosis, so-called “programmed cell death”.

When used in the treatment of humans in need thereof, it is well-known that these drugs very often are used in combination with other cancer treatments, such as radiation therapy or surgery. Alternatively, the patients may be treated with a number of different drugs simultaneously. The drugs differ in their mechanism and side effects, but the biggest advantage of the combinatorial administration is that the chances of developing resistance towards any one of said anti-cancer agents is minimised. Hence, testing anti-cancer agents for a synergistic effect when used as combinatorial drugs is highly relevant, as is testing one or more such agents together with one or more monoclonal antibodies as discussed above.

The majority of anti-cancer agents can be divided into alkylating agents, antimetabolites, antitumor antibiotics, plant alkaloids, topoisomerase inhibitors and other antitumour agents. All of these drugs affect to some extent cell division or DNA synthesis and function. In addition, agents which do not directly interfere with DNA have also been developed. These include monoclonal antibodies and tyrosine kinase inhibitors, e.g. imatinib mesylate, which directly targets a molecular abnormality in certain types of cancer (chronic myelogenous leukemia, gastrointestinal stroma tumors). In addition, drugs which modulate tumor cell behaviour without directly attacking those cells are also designated as anti-cancer agents. Hormones fall into this category.

Alkylating agents have the ability to add alkyl groups to many electronegative groups under conditions present in cells. Cisplatin, carboplatin and oxaliplatin are examples of alkylating agents. Other agents also belonging to this group include mechlorethamine, cyclophosphamide and chlorambucil, which work by chemically modifying a cell's DNA.

Antimetabolites masquerade as purine (azathioprine, mercaptopurine) or pyrimidine, and they prevent these substances becoming incorporated in to DNA during the “S” phase of the cell cycle, stopping normal development and division. They also affect RNA synthesis.

Antitumor antibiotics (also known as antineoplastics and cytotoxic antibiotics) are drugs that inhibit and combat the development of tumors. Anthracyclines, which belong to this group, are a family of anti-cancer agents which also act as antibiotics. The anthracyclines act to prevent cell division by disrupting the structure of the DNA and terminating its function. They do so either by intercalating into the base pairs in the DNA minor grooves or by causing free radical damage of the ribose in the DNA. As examples of anthracyclines can be mentioned: daunorubicin, doxorubicin, epirubicin and idarubicin. Other examples of drugs belonging to the group of antitumor antibiotics include actinomycin, bleomycin, plicamycin and mitomycin.

Plant alkaloids are derived from plants and block cell division by preventing microtubule function. Microtubules are vital for cell division and without them cell division cannot occur. The main examples of plant alkaloids include vinca alkaloids, such as vincristine, vinblastine, vinorelbine and vindesine, and taxanes, such as paclitaxel and docetaxel. Topoisomerase inhibitors are essential enzymes that maintain the topology of DNA. Inhibition of type I and II topoisomerases interferes with both transcription and replication of DNA by upsetting proper DNA supercoiling. Examples of type I topoisomerase inhibitors include camptothecins, such as irinotecan and topotecan, whereas examples of type II topoisomerase inhibitors include amsacrine, etoposide, etoposide phosphate and teniposide.

### Anti-AIDS Agents

Anti-AIDS or anti-HIV agents, also known as antiretroviral drugs, are designed for the treatment of infection by retroviruses, primarily HIV. When several such drugs (typically three or four) are taken in combination, the approach is known as highly active antiretroviral therapy, or HAART. Hence, combinatorial drug therapy is a well-known approach in the treatment of HIV and AIDS. This class of agents is therefore very relevant to be tested in the method according to the present invention, either this class alone or in combination with one or more monoclonal antibodies as discussed above.

Anti-AIDS agents are broadly classified by the phase of the retrovirus life-cycle that the drug inhibits. One class of anti-AIDS agents is nucleoside and nucleotide reverse transcriptase inhibitors (NRTI), which inhibit reverse transcription by being incorporated into the newly synthesized viral DNA and preventing its further elongation. Zidovudine, lamivudine, emtricitabine, abacavir, tenofovir, disoproxil fumarate and stavudine are examples of agents belonging to this group.

Another class of anti-AIDS agents is the non-nucleoside reverse transcription inhibitors (nNRTI), which inhibit reverse transcriptase directly by binding to the enzyme and interfering with its function. Etravirine, delavirdine, and efavirenznevirapine are examples of agents in this class.

The protease inhibitors (PIs) is yet another class of anti-AIDS agents which target viral assembly by inhibiting the activity of protease, which is an enzyme used by HIV to cleave nascent proteins for final assembly of new virons. Amprenavir, tipranavir, indinavir, saquinavir, fosamprenavir, ritonavir, darunavir, atazanavir and nelfinavir are examples of agents belonging to this group.

Another class is the integrase inhibitors, which inhibit the enzyme integrase, which is responsible for integration of viral DNA into the DNA of the infected cell. There are several integrase inhibitors currently in clinical trials. Raltegravir was the first such agent to receive FDA approval in October 2007.

Entry inhibitors (or fusion inhibitors) comprise another class of anti-AIDS agents. These agents interfere with binding, fusion and entry of HIV-1 to the host cell by blocking one of several targets. Maraviroc and enfuvirtide are two currently available agents in this class.

Yet another class is the maturation inhibitors. This class of agents inhibit the last step in gag processing in which the viral capsid polyprotein is cleaved, thereby blocking the conversion of the polyprotein into the mature capsid protein (p24). Because these viral particles have a defective core, the virions released consist mainly of non-infectious particles. Bevirimat and vivecon belong to this group of agents.

It is also well-known that synergistic enhancers exist within this technical field. Synergistic enhancers either do not possess antiretroviral properties alone or are inadequate or impractical for monotherapy, but when they are taken concurrently with antiretroviral drugs they enhance the effect of one or more of those drugs (often by altering the metabolism of antiretrovirals). Hence, when the term “anti-AIDS agents” is used it is to be understood as including these synergistic enhancers.

### Anti-Growth Factors

Agents that target growth factors secreted by tumors may be used to combat angiogenesis and thus reduce tumor growth. An example of such an agent is bevacizumab (Avastin), which is available as a signal-blocking angiogenesis inhibitor directed against vascular endothelial growth factor (VEGF). Other growth factors involved in tumor angiogenesis include the fibroblast growth factors (FGFs) and epidermal growth factor (EGF).

### Antiviral Agents

Antiviral agents are defined as substances that have the capacity to stimulate cellular defenses against viruses. An antiviral agent can for example reduce cell DNA synthesis, thus making cells more resistant to viral genes, enhancing cellular immune responses or suppressing viral replication. Antiviral drugs are available to treat only a few viral diseases, because viral replication is so intimately associated with the cells in the body to be treated that any drug that interferes significantly with viral replication is likely to be toxic to the body to be treated.

Antiviral agents can be divided into two groups: the nucleoside analogues and the interferons. Anti-AIDS agents are discussed separately above.

Nucleoside analogues are synthetic compounds which resemble nucleosides, but have an incomplete or abnormal deoxy-ribose or ribose group. These compounds are phosphorylated to the tri-phosphate form within the infected cell. In this way, the drug competes with normal nucleotides for incorporation into viral DNA or RNA. Incorporation into the growing nucleic acid chain results in irreversible association with the viral polymerase and chain termination. Examples of nucleoside analogues are acyclovir, gancyclovir, idoxuridine, ribavirin, dideoxyinosine, dideoxycytidine and zidovudine.

Interferons can be divided into three classes, namely alpha-, beta- and gamma-interferon. The alpha- and beta-interferons are cytokines which are secreted by virus infected cells. They bind to specific receptors on adjacent cells and protect them from infection by viruses. They form part of the immediate protective host response to invasion by viruses. In addition to these direct antiviral effects, alpha- and beta-interferon also enhance the expression of class I and class II MHC molecules on the surface of the infected cells, thus enhancing the presentation of viral antigens to specific immune cells. Recombinant alpha- and beta-interferons are available and can be used for the treatment of chronic hepatitis B and C virus infections. Gamma-interferon (also known as immune interferon) is a cytokine secreted by TH1 CD4 cells. Its function is to enhance specific T cell mediated immune responses.

### Soluble Receptors

The term “receptor” is used here in accordance with the term's conventional meaning in the context of receptor-ligand binding, and is not to be construed as encompassing antibodies. The term “soluble” distinguishes the receptors from their cell membrane-bound counterparts, as is understood in the field of cytokine receptors. Soluble receptors comprise an extracellular (ligand binding) domain, but lack the transmembrane region that causes retention of a receptor on the cell surface. The soluble receptors generally lack the intracellular (cytoplasmic) domain as well.

Naturally occurring soluble forms of certain receptors are known to exist. For example, soluble receptors are known to be naturally occurring for a variety of hormones; for example, insulin receptor, IL-2 receptor, insulin-like growth factor (IGF-II) receptor, EGF receptor, platelet-derived growth factor (PDGF) receptor, and Fc receptors. These soluble or truncated receptors appear to have similar binding properties to those of their membrane-bound counterparts. Soluble receptors can be ligated through recombinant expression to other polypeptides, e.g. Fc receptors, and to ligands.

Abnormalities in signal transduction pathways, in the form of either under-activation (e.g. lack of ligand) or over-activation (e.g. too much ligand), are the underlying causes of pathological conditions and diseases such as arthritis, cancer, AIDS and diabetes. One of the current strategies for treating these debilitating diseases involves the use of receptor decoys, such as soluble receptors consisting of only the extracellular ligand-binding domain, to intercept a ligand and thus overcome the over-activation of a receptor. An example of this strategy is the creation of Enbrel®, a dimeric soluble TNF-alpha receptor-immunoglobulin (IgG) fusion protein by Immunex/Amgen. The TNF family of cytokines is one of the major pro-inflammatory signals produced by the body in response to infection or tissue injury. However, abnormal production of these cytokines, for example in the absence of infection or tissue injury, has been shown to be one of the underlying causes of diseases such as arthritis and psoriasis. Accordingly, fusing a soluble TNF-alpha receptor with the Fc region of immunoglobulin G1, which is capable of spontaneous dimerization via disulfide bonds, allows the secretion of a dimeric soluble TNF-alpha receptor. In comparison with the monomeric soluble receptor, the dimeric TNF-alpha receptor II-Fc fusion has a greatly increased affinity to the homo-trimeric ligand. This provides a molecular basis for its clinical use in treating rheumatoid arthritis (RA), an autoimmune disease in which constitutively elevated TNF-alpha plays an important causal role.

Due to their fundamental involvement in the pathogenesis of many diseases, cytokines constitute another class of targets for biotherapeutic approaches. The discovery that soluble forms of cytokine receptors are involved in the endogenous regulation of cytokine activity has prompted substantial interest in their potential application as immunotherapeutic agents.

### RNAi's

RNA interference (RNAi) is a mechanism that inhibits gene expression at the stage of translation or by hindering the transcription of specific genes. RNAi targets include RNA from viruses and transposons (significant for some forms of innate immune response), and they also play a role in regulating development and genome maintenance. The RNAi pathway is initiated by the enzyme dicer, which cleaves long dsRNA molecules into short fragments of 20-25 base pairs. One of the two strands of each fragment, known as the guide strand is then incorporated into the RNA-induced silencing complex (RISC) and pairs with complementary sequences. The most well-studied outcome of this recognition event is post-transcriptional gene silencing. This occurs when the guide strand specifically pairs with an mRNA molecule and induces cleavage by argonaute, the catalytic component of the RISC complex. Another outcome is epigenetic changes to a gene—histone modification and DNA methylation—affecting the degree the gene is transcribed.

RNA interference is a vital part of immune response to viruses and other foreign genetic material, especially in plants where it may also prevent self-propagation by transposons. In general, animals express fewer variants of the dicer enzyme than plants. RNAi in some animals has been shown to produce an antiviral response.

The RNA interference pathway is often exploited in experimental biology to study the function of genes in cell culture and in vivo in model organisms. Double-stranded RNA is synthesized with a sequence complementary to a gene of interest and introduced into a cell or organism, where it is recognised as exogenous genetic material and activates the RNAi pathway. Using this mechanism, researchers can cause a drastic decrease in the expression of a targeted gene. Studying the effects of this decrease can show the physiological role of the gene product. Since RNAi may not totally abolish expression of the gene, this technique is sometimes referred to as a “knockdown”, to distinguish it from “knockout” procedures in which expression of a gene is entirely eliminated.

It may be possible to exploit RNA interference in therapy. Although it is difficult to introduce long dsRNA strands into mammalian cells due to the interferon response, the use of short interfering RNA mimics has been more successful. Among the first applications to reach clinical trials were in the treatment of macular degeneration and respiratory syncytial virus, RNAi has also been shown to be effective in the reversal of induced liver failure in mouse models.

Other proposed clinical uses relate to antiviral therapies, including the inhibition of viral gene expression in cancerous cells, knockdown of host receptors and coreceptors for HIV, the silencing of hepatitis A and hepatitis B genes, silencing of influenza gene expression, and inhibition of measles viral replication. Potential treatments for neurodegenerative diseases have also been proposed, with particular attention being paid to the polyglutamine diseases such as Huntington's disease. RNA interference is also often seen as a promising way to treat cancer by silencing genes differentially upregulated in tumor cells or genes involved in cell division. A key area research in the use of RNAi for clinical applications is the development of a safe delivery method, which to date has involved mainly viral vector systems similar to those suggested for gene therapy.

### Vaccines

A vaccine is a biological preparation which is used to establish or improve immunity to a particular disease. Vaccines can be prophylactic (e.g. to prevent or ameliorate the effects of a future infection by any natural or “wild” pathogen) or therapeutic (e.g. vaccines to be used in the treatment of a medical conditions such as for example cancer). Vaccines may be made of dead or inactivated organisms or purified products derived from them. There are four types of traditional vaccines.

One type is vaccines containing killed microorganisms. These are previously virulent micro-organisms which have been killed with chemicals or heat. Examples are vaccines against flu, cholera, bubonic plague and hepatitis A.

Another type is vaccines containing live, attenuated virus microorganisms. These are live micro-organisms that have been cultivated under conditions that disable their virulent properties or live micro-organisms which are closely related to dangerous micro-organisms, but are themselves less dangerous, and produce a broad immune response. They typically provoke more durable immunological responses and are the preferred type for healthy adults. Examples include yellow fever, measles, rubella and mumps. The live tuberculosis vaccine is not the contagious strain, but a related strain called “BCG”; it is used in the United States very frequently.

A third type of vaccines is toxoids. A toxoid is a bacterial toxin (usually an exotoxin) whose toxicity has been weakened or suppressed either chemical (formalin) or by heat treatment, while other properties, typically immunogenicity, are maintained. Toxoids are useful as vaccines because they induce an immune response to the original toxin or increase the response to another antigen. For example, the tetanus toxoid is derived from the tetanospasmin produced by Clostridium tetani that causes tetanus. The tetanus toxoid is used for the development of plasma rich vaccines.

The fourth type of vaccines is referred to as subunits. Rather than introducing an inactivated or attenuated microorganism to an immune system (which would constitute a “whole-agent” vaccine), a fragment of it can create an immune response. Examples include the subunit vaccine against HBV, which is composed of only the surface proteins of the virus (produced in yeast) and the virus-like particle (VLP) vaccine against human papillomavirus (HPV), which is composed of the viral major capsid protein.

A number of innovative vaccines are also in development and in use. These include conjugate, recombinant vector and DNA vaccination. The conjugate technique makes use of the fact that certain bacteria have polysaccharide outer coats that are poorly immunogenic. By linking these outer coats to proteins (e.g. toxins), the immune system can be led to recognise the polysaccharide as if it were a protein antigen. This approach is used in the Haemophilus influenzae B vaccine. In the recombinant vector technique the physiology of one microorganism and the DNA of another are combined, whereby immunity can be created against diseases that have complex infection processes. DNA vaccination is a new type of vaccine created from an infectious agent's DNA. It works by insertion (and expression, triggering immune system recognition) into human or animal cells of viral or bacterial DNA. Some cells of the immune system that recognize the proteins expressed will mount an attack against these proteins and cells expressing them. Because these cells live for a long time, if the pathogen that normally expresses these proteins is encountered at a later time, they will be attacked instantly by the immune system. One advantage of DNA vaccines is that they are very easy to produce and store.

### EXAMPLES

### Example 1

To be able to select a combinatorial drug with the highest potency and efficacy, it is necessary to be able to screen a large number of combinations in a high-throughput manner. Such a task is not trivial, as 40 drug candidates can be combined in combinations of 10 in more than 800 million ways. The most interesting mixtures are the ones named “unique combinations”, which are mixtures not containing overlapping drug candidates. The number of unique combinations (UC) of a number of n drug candidates in a mixture of r drug candidates can be calculated from the following equation:

$$UC = \frac{n !}{( n - r ) ! * r !}$$

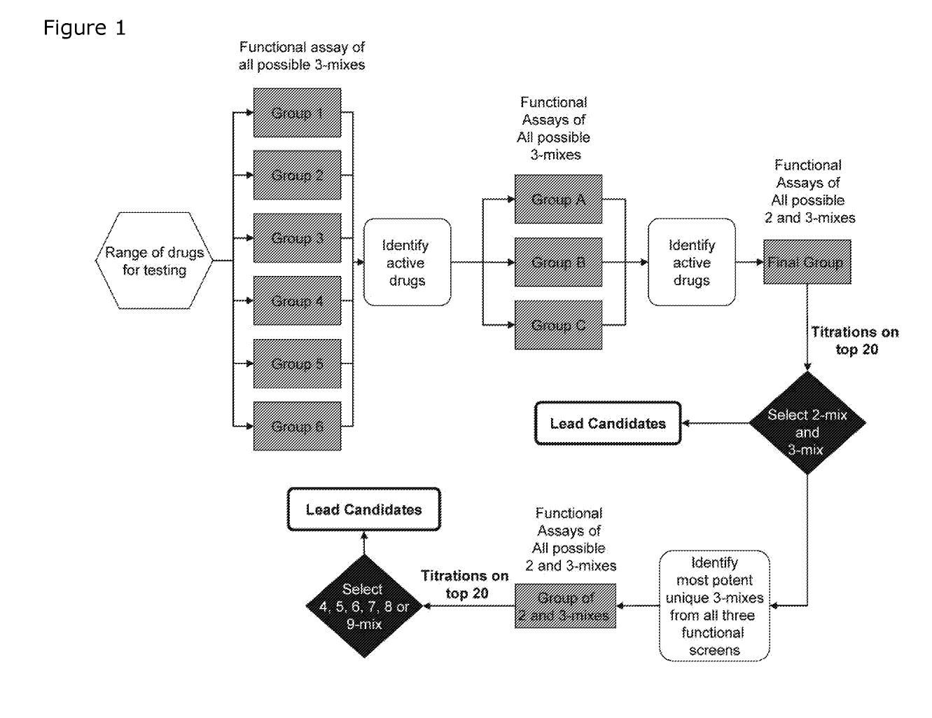

This function describes parabolic curves. One solution to the very high number of combinations to test is to break down into groups of drug candidates and to test these in smaller mixtures. Once the best combinations of these smaller mixtures are identified, they can be combined to generate larger combinations which can then be tested. An outline of the selection process can be seen in FIG. 1.

### Method

A range of drug candidates with known activity as single drugs are divided into groups of up to 32 and all possible 3-mixes of these drug candidates are then tested for activity in one, two or more functional assays. In each group the drug candidates that contribute the most to activity of the mixtures are selected, divided into one or more groups if necessary, and tested again in all possible 3-mixes (FIG. 1). This process is repeated until the number of drug candidates selected is 12 or less. The 12 drug candidates are then tested in all possible 2- and 3-mixes and titrations are performed on the 20 most efficacious of these combinations. The most potent 2 and 3-mixes can then be selected as lead candidates. The most potent unique 2- and 3-mixes (not containing overlapping drug candidates) are then selected and treated as single drugs. All possible 2- and 3-mixes of these pre-defined drug combinations are then tested and titrations are performed on the 20 most potent of these combinations of mixtures. After titrations the most potent 4, 5, 6, 7, 8 or 9 mixes of drug candidates can be selected as lead candidates. Finally, lead candidates can be compared in a range of assays to determine the most optimal drug combination.

### Example 2

Example 2 describes a way of generating 2, 3, 4 and 5 mixes of up to 32 drug candidates in a high throughput manner.

### Method

The selected number of drug candidates is divided into groups of up to 8 for 96 well plates, up to 16 for 384 well plates and up to 32 for 1536 well plates. The drug candidates are then diluted to an appropriate concentration and transferred to source plates (feeder plates) so that the first source plate contains a column with one drug candidate in each well. The second source plate contains columns with one drug candidate in each. An automatic pipetting system such as a Biomek® 3000 laboratory automation workstation (Beckman Coulter) is used to transfer a specified volume of drug candidates from the first column of the source plate to all columns of 8 96 well plates, 16 384 well plates or 32 1536 well plates. The next layer of drug candidate is added by transferring a similar volume of drug candidates from the columns of the second source plate to the corresponding columns on the receiver plates (destination plates).

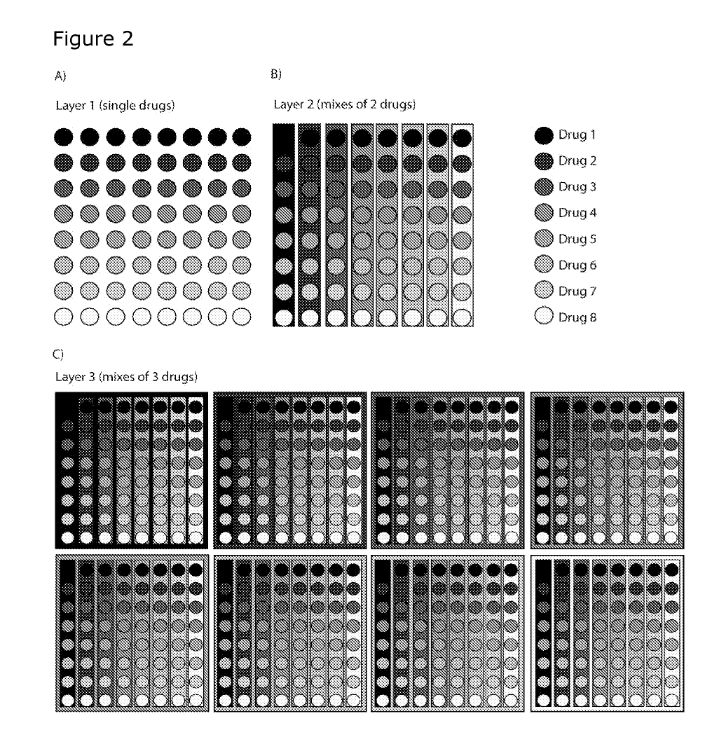

A third layer is added by transferring a similar volume of the contents of the first column of the second source plate to all columns of the first receiver plate, and then the contents of the second column of the second source plate to all columns of the second receiver plate. A schematic illustration of the layout of the receiver plate after addition of the first, second and third layer of 8 drug candidates to a 96 well plate is shown in FIG. 2. A) Layer 1, B) layers 1+2 and C) layers 1+2+3. The 8 drug candidates are shown in different shades of grey.

A fourth or fifth layer of drug candidate can be added by repeating the last process with the number of receiver plates increasing by a factor of the number of drug candidates for four layers and again by a factor of the number of drug candidates for five layers. In the case of 8 drug candidates in 96 well plates, this gives 64 plates for 4 layers and 512 plates for five layers.

### Results

There are several obvious advantages of generating mixtures of drug candidates in this type of matrix-like format. One advantage is that all unique mixtures are generated in multiple wells (six in this case) located at different sites on the receiver plates (FIG. 2). This is optimal for functional testing of the drug candidate mixtures as inter- and intra-plate variations are equalized as well as potential biological variation. Mixtures are also generated which contain ⅔ of one drug candidate and ⅓ of a second drug candidate.

These are also placed on different plates and are found in triplicate. These mixtures, called skewed mixtures, can provide useful information on the contribution of the individual drug candidates to combinations.

### Example 3

This example illustrates the processes described in Examples 1 and 2 by breaking down 23 antibodies into groups of 12 antibodies which are then tested in all combinations of 3 antibodies in a standard viability assay in a 384 well format. The 12 most efficacious antibodies of the 23 are selected and tested again in all possible combinations of 3 antibodies.

### Method

23 antibodies with confirmed binding to the human EGF receptor (EGFR) numbered as 992, 1024, 1030, 1183, 1194, 1211, 1214, 1242, 1254, 1255, 1257, 1260, 1261, 1277, 1284, 1305, 1308, 1317, 1320, 1449, 1564, 1565 and 1566, were selected for the screening. Each antibody was diluted to a concentration of 40 μg/ml in 1×PBS and added to 96-well source plates. In each group, a Biomek® 3000 laboratory automation workstation (Beckman Coulter) was used to add 2 μl of the 12 antibodies to wells in 12 384 well plates containing 30 μl of media so that row A contained 2 μl of the first antibody, row B 2 μl of the second antibody and so forth until all twelve rows on all twelve plates contained antibody. The next layer of antibody was then added; this time the first antibody was added to column 1, the second antibody to column 2 and so forth until all wells on all twelve plates contained two antibodies. The third layer was then added by pipetting 2 μl of antibody 1 to all wells on plate 1 and 2 μl of antibody 2 to all wells on plate 2 and so forth until all wells contained 3 antibodies in a volume of 6 μl. The final antibody concentration in each well was 4 μg/ml.

30 μl of media containing 500 A431NS cells were then added to all wells containing antibody as well as to two columns without antibody which functioned as negative controls. The plates were then incubated for 3 days in a humidified incubator at 37° C., after which 8 μl of the cell proliferation reagent WST-1 diluted 1:1 in 1×PBS was added to wells on all plates. Hereafter the plates were incubated for 1 hour at 37° C. The plates were then transferred to orbital shakers and incubated for another hour. The absorbance was measured at 450 and 620 nm (reference wavelength) on an ELISA reader. The amount of metabolically active cells (MAC) was calculated as percent of the untreated control as follows:

$$\% MAC = ( \frac{( ODexp . - ODmedia )}{( ODuntreat . - ODmedia )} ) \times 100$$

It was assumed that the metabolic activity correlates with the number of viable cells.

### Results

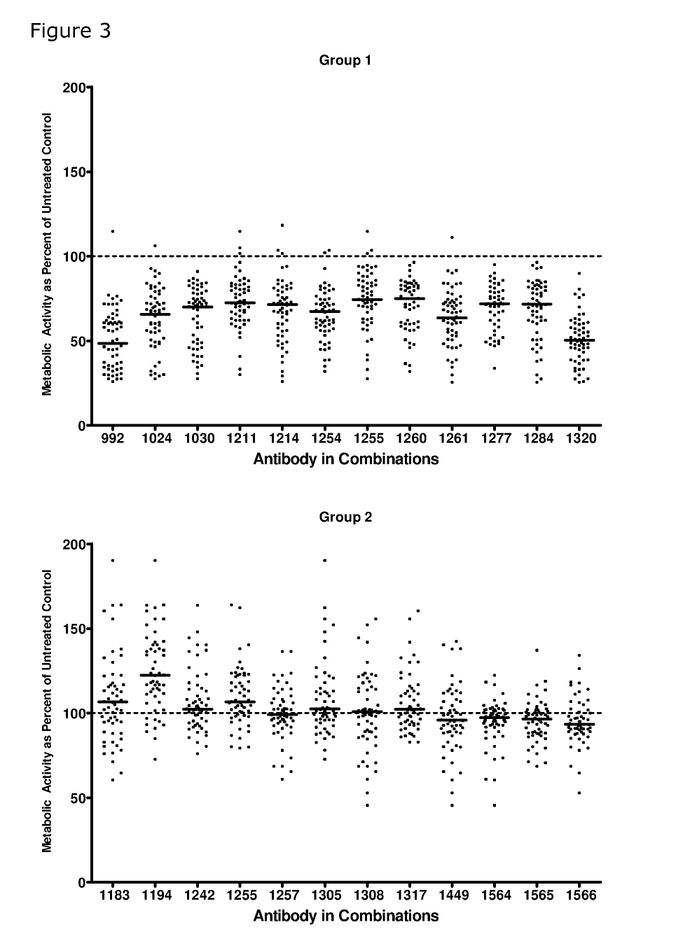

The 23 antibodies were divided into two random groups of 12 so that group 1 contained antibodies 992, 1024, 1030, 1211, 1214, 1254, 1255, 1260, 1261, 1277, 1284 and 1320, while group 2 contained antibodies 1183, 1194, 1242, 1255, 1257, 1305, 1308, 1317, 1449, 1564, 1565 and 1566. Antibody 1255 was included in both groups because of the uneven number. All possible 3-mixes of antibodies within each group were generated as described above and tested for effect on cell growth. The % MAC was calculated for the 12 monoclonal antibodies, the 220 unique antibody mixtures and the 132 skewed mixtures. The mixtures were then ranked according to their effect on cell growth. In order to be able to select the antibodies which contributed the most to the efficacy of the mixtures, the % MAC for mixtures containing a particular antibody were plotted against the antibody and the median % MAC was calculated. Scatter plots of the % MAC for the mixtures containing the antibodies in group 1 and group 2 can be seen in FIG. 3. It is evident that in group 1 antibodies 992, 1024, 1030, 1254, 1261 and 1320 are the most efficacious in mixtures, whereas antibodies 1257, 1308, 1449, 1564, 1565 and 1566 are the most potent in mixtures in group 2. Antibodies in group 1 also appeared more potent compared to mixtures of antibodies in group 2, although the groups cannot be compared directly as they are from different experiments. Six antibodies from each group were selected for the final group. These were 992, 1024, 1030, 1257, 1261, 1284, 1308, 1320, 1449, 1564, 1565 and 1566. % MAC values of the 20 most potent mixtures as well as scatter plots of the results of the second round of screening are shown in FIG. 4. The two mixtures with the highest efficacies were 992+1308+1566 and 992+1308+1320. In fact, 19 of the mixtures with the highest efficacy contained antibody 992, showing that this antibody works well in combination with other anti EGFR antibodies. Although antibody 992 has a fairly high efficacy on its own, it was found to be augmented by other antibodies.

### Example 4

This example describes the testing of all possible 2-mixes of the 12 antibodies selected in Example 3 in a similar viability assay.

### Method

The 12 antibodies found to contribute the most to the efficacy of the 3-mixes, namely 992, 1024, 1030, 1257, 1261, 1284, 1308, 1320, 1449, 1564, 1565 and 1566, were tested in all possible 2-mixes. Each antibody was diluted to a concentration of 40 μg/ml in 1×PBS and added to 96-well source plates. In each group a Biomek® 3000 laboratory automation workstation (Beckman Coulter) was used to add 3 μl of the 12 antibodies to wells in one 384 well plate containing 30 μl of media so that row A contained 3 μl of the first antibody, row B 3 μl of the second antibody and so forth until all twelve contained antibody. The next layer of antibody was then added, this time the first antibody was added to column 1, the second antibody to column 2 and so forth until all wells on all twelve plates contained two antibodies in a total volume of 6 μl. The final antibody concentration in each well was 4 μg/ml.

30 μl of media containing 500 A431NS cells were then added to all wells containing antibody as well as to two columns without antibody which functioned as negative controls. The plates were then incubated for 3 days in a humidified incubator at 37° C., after which 8 μl of the cell proliferation reagent WST-1 diluted 1:1 in 1×PBS was added to wells on all plates. Hereafter the plates were incubated for 1 hour at 37° C. The plates were then transferred to orbital shakers and incubated for another hour. The absorbance was measured at 450 and 620 nm (reference wavelength) on an ELISA reader. The amount of metabolically active cells (MAC) was calculated as described above.

### Results

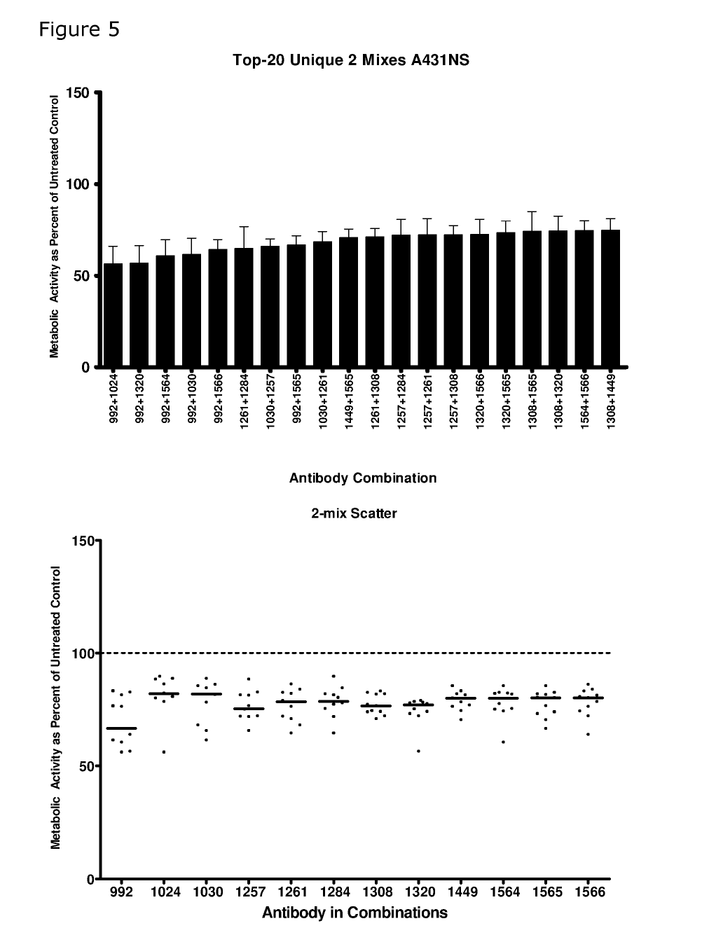

The % MAC was calculated for the 12 monoclonal antibodies and the 66 unique antibody mixtures. The mixtures were then ranked according to their effect on cell growth, the 20 mixtures with the highest efficacy being shown in FIG. 5 (at the top). The combination of antibodies 992 and 1024 has the highest efficacy. Scatter plots of the % MAC for the mixtures can be seen in FIG. 5 (at the bottom). Again, it is evident that antibody 992 performs best in combination with the other antibodies.

All patent and non-patent references cited herein are hereby incorporated by reference in their entirety.

1. A method for identifying and selecting chemical entities possessing or contributing to a functional effect in order to provide a mixture comprising at least 2 chemical entities showing a desired functional effect, said method comprising the steps of:
a) providing n samples each comprising a chemical entity to be tested,
b) mixing 2 or more of said n samples in all possible combinations in order to obtain a first set of mixtures to be tested,
c) subjecting said first set of mixtures to a functional assay capable of measuring a functional parameter in order to identify chemical entities contributing to the functional effect,
d) selecting m samples each comprising a chemical entity contributing to the functional effect in step c), wherein m is less than n;
e) mixing two or more of said m samples in all possible combinations in order to obtain a second set of mixtures to be tested;
f) subjecting said second set of mixtures to a functional assay capable of measuring a functional parameter in order to identify chemical entities contributing to the functional effect; and
g) selecting a mixture possessing the desired functional effect.

2. The method according to claim 1, wherein steps d, e and f are repeated on separate sub-pools each comprising m selected samples.

3. The method according to claim 2, wherein steps d, e and f are repeated 1, 2, 3, 4, 5, 6, 7, 8, 9 or 10 times, and where the steps are repeated in parallel or sequentially.

4. The method according to claim 1, wherein a mixture comprising 3 chemical entities is identified and selected by mixing 3 of said n samples in step b.

5. The method according to claim 2, wherein a mixture comprising 3 chemical entities is identified and selected by mixing 3 of said n samples in step b, and where 3 of said m samples are mixed in step (e).

6. The method according to claim 1, said method comprising the steps:
d1) selecting m1 mixtures possessing the desired functional effect;
e1) mixing 2, 3, 4 or 5 of said m1 mixtures selected in step d1 in all possible combinations;
f1) subjecting said mixtures of step e1 to a functional assay capable of measuring a functional parameter in order to identify mixtures contributing to a functional effect; and
g1) selecting from the mixtures of step e1 a second mixture possessing the desired functional effect.

7. The method according to claim 6, said method further comprising the steps of:
h) mixing 2, 3, 4 or 5 of the selected mixtures obtained in step g1,
i) subjecting said mixtures to a functional assay capable of measuring a functional parameter in order to identify mixtures contributing to a functional effect, and
j) selecting a third mixture possessing the desired functional effect.

8. The method according to claim 6, wherein any chemical entity only appears once in any of the mixtures mixed in step e1.

9. The method according to claim 8, wherein the any chemical entity only appears once in any of the mixtures mixed in step h.

10. The method according to claim 1, wherein the identification as to whether a particular chemical entity contributes to the functional effect is performed by comparing the functional effect of a mixture comprising said chemical entity with the functional effect of one or more mixtures not comprising said chemical entity.

11. The method according to claim 1, wherein the identification of whether a particular chemical entity contributes to the functional effect is, performed by comparing the functional effect of a mixture comprising said chemical entity and other chemical entities with the functional effect of a mixture only comprising said-chemical entity.

12. The method according to claim 1, wherein the identification as to whether a particular chemical entity contributes to the functional effect is performed by comparing the functional effect of a mixture comprising said chemical entity with a reference value.

13. The method according to claim 12, wherein the reference value is a predetermined value and where the identified functional effect of the mixture comprising said chemical entity must be either higher than, equal to or less than the predetermined value in order for the chemical entity to contribute to the functional effect, or the reference value is an interval within which the identified functional effect of the mixture comprising said chemical entity must lie in order for the chemical entity to contribute to the functional effect.

14. The method according to claim 1, wherein the identification of chemical entities contributing to the functional effect is performed by identifying the chemical entities which appear most frequently in the mixtures possessing the functional effect.

15. The method according to claim 1, wherein n is an integer having a value of 3 or more.

16. The method according claim 1, wherein m is an integer having a value of 3 or more.

17. The method according to claim 1, wherein the compounds comprised in any of the chemical entities to be tested are selected from the group consisting of antibodies, antibiotics, anti-cancer agents, anti-AIDS agents, anti-growth factors, antiviral agents, soluble receptors, cytokines, RNAi's, vaccines and mixtures thereof.

18. The method according to claim 17, wherein the compounds comprised in the chemical entity to be tested are a combination of two or more antibodies; or one or more antibodies in combination with at least one non-antibody compound.

19. The method according to claim 17, wherein the compounds comprised in the chemical entities to be tested are monoclonal antibodies.

20. The method according to claim 19, wherein the compounds comprised in the chemical entity to be tested include a) one or more monoclonal antibodies, and b) at least one additional therapeutic agent that provides a desired functional effect in combination with the one or more antibodies of a).

21. The method according to claim 1, wherein the functional parameter to be measured is selected from the group consisting of exertion of a physical effect, binding to a ligand, exertion of catalytic activity, susceptibility to catalytic activity, facilitation of altered transport of an agent across a biological membrane, facilitation of altered translocation of an agent in the intracellular compartment, influence on expression of at least one gene in a population of eukaryotic cells, influence on the growth or metabolism of a population of eukaryotic cells, influence on target cells, influence on a pathogenic agent, influence on secondary immune effects, influence on the ability of the compound to be expressed, manufactured or formulated, and influence on stability.

22. The method according to claim 21, wherein the mixtures to be tested are subjected to two or more functional assays capable of measuring a functional parameter in order to independently measure two or more functional parameters of each mixture.

23. The method according to claim 21, wherein the functional parameter is the influence on the growth or metabolism of a population of eukaryotic cells, influence on target cells or influence of the compound on target cells.

24. The method according to claim 1, wherein the method is performed in multiwell plates or by use of automated pipetting or by use of robotics.

25. A method for identifying and selecting an optimal stoichiometric ratio between chemical entities in a mixture comprising at least 2 chemical entities, said mixture showing a desired functional effect, the method comprising the steps of:
aa) providing p samples each comprising one chemical entity to be present in the mixture,
bb) diluting each of said p samples q times in order to obtain p series of samples each comprising the same chemical entity at different concentrations,
cc) mixing 2 or more of the samples obtained in steps aa and bb in all possible combinations in order to obtain mixtures to be tested,
dd) subjecting said mixtures to a functional assay capable of measuring a functional effect in order to identify the relationship between the measured functional effect and the concentration of the chemical entities in the mixture, and
ee) selecting the mixture possessing the desired functional effect.

26. The method according to claim 25, wherein the samples are diluted by a factor of 2, 5, 10, 20, 50 or 100 in step bb.

27. The method according to claim 25, wherein p is an integer having a value of 2 or more.

28. The method according to claim 25, wherein q is an integer having a value of 1, 2, 3, 4 or 5.

29. The method according to claim 15, wherein n is an integer having a value between 3 and 1440.

30. The method according to claim 16, wherein m is an integer having a value between 3 and 720.

31. The method according to claim 27, wherein p is an integer having a value between 2 and 24.
